(19) United States
(12) Patent Application Publication
(10) Pub. No.: US 2023/0409940 A1
(43) Pub. Date: Dec. 21, 2023

(54) QUANTUM COMPUTER SLICING MECHANISM

(71) Applicant: Dell Products L.P., Round Rock, TX (US)

(72) Inventors: Benjamin Santaus, Somerville, MA (US); Brendan Burns Healy, Whitefish Bay, WI (US); Victor Fong, Melrose, MA (US)

(21) Appl. No.: 17/807,448

(22) Filed: Jun. 17, 2022

(51) Int. Cl. G06N 10/20

(52) U.S. Cl. CPC G06N 10/20

(57) ABSTRACT

Quantum processing unit slicing is disclosed. The qubits of a quantum processing unit are sliced or grouped to accommodate multiple independent and separate quantum jobs. The quantum jobs are matched, based on user tolerances related to at least number of shots, and the quantum jobs are then merged and performed. The results for each of the specific quantum jobs concurrently performed are extracted from the overall results of the quantum processing unit.

### FIELD OF THE INVENTION

Embodiments of the present invention generally relate to quantum processing units. More particularly, at least some embodiments of the invention relate to systems, hardware, software, computer-readable media, and methods for consuming quantum computing including distributing quantum jobs to quantum processing units.

### BACKGROUND

Quantum processing units (QPUs) are often used in conjunction with computer processing units (CPUs). However, quantum processing units execute quantum circuits rather than compiled code. Quantum processing units are often offered as a service that can be accessed much like accessing cloud compute services. In a hybrid computing system, a classical computing system may be configured to execute jobs that include portions executed by the CPU and portions executed by the QPU.

QPUs are often offered as services and can be accessed by jobs. However, the QPUs offered by different vendors or providers may have different configurations and characteristics. When a user is selecting a QPU, the selection may be driven or influenced by the characteristics of the quantum circuit the user would like to execute on the QPU and/or the characteristics of the QPU. If the user's quantum circuit is associated with n qubits, the user will select a quantum processing unit that has at least n qubits. In many instances, the number of qubits available on any given QPU unit is larger than the number of qubits required to execute the quantum circuit.

From the vendor's perspective, this leaves resources idle and unproductive at least part of the time. The inefficient user of the vendor's resources may result in increased wait times.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of a quantum circuit executed by a quantum processing unit;

FIG. 2 discloses aspects of distributing a quantum job to a quantum processing unit;

FIG. 3 discloses aspects of distributing quantum jobs to a quantum processing unit for concurrent execution;

FIG. 4 discloses aspects of distributing multiple quantum jobs to a quantum processing unit for execution at the same time; and

FIG. 5 discloses aspects of a computing device, a computing system, a hybrid computing system, or a computing entity.

### DETAILED DESCRIPTION OF SOME EXAMPLE EMBODIMENTS

Embodiments of the present invention generally relate to quantum processing units. More particularly, at least some embodiments of the invention relate to systems, hardware, software, computer-readable media, and methods for a quantum slicing mechanism that allows quantum processing units to be used more efficiently.

In general, example embodiments of the invention relate to distributing quantum jobs to more effectively use quantum computing resources. Embodiments of the invention allow a quantum processing unit to process multiple quantum jobs simultaneously. Generally, embodiments of the invention may evaluate the quantum jobs that have been submitted for execution. Assuming that a user has granted permission for their quantum job to be run concurrently with another user's quantum job, the quantum jobs can be performed at the same time on the same quantum processing unit. A quantum processing unit may be sliced, in effect, into multiple quantum processing units that can each handle of the quantum jobs that can be run concurrently.

For example, a quantum processing unit that offers 50 qubits can accommodate any numbers of quantum jobs as long as the qubits associated with those quantum jobs sum to 50 or less. As discussed in more detail below, embodiments of the invention account for other aspects of the quantum jobs, such as number of shots. When a quantum processing unit is sliced, the results output by the quantum processing unit may need to be sliced into multiple outputs, each corresponding to one of the input quantum jobs. Embodiments of the invention thus separate or extract the results for the each of the quantum jobs that have been performed from the overall results of the quantum processing unit.

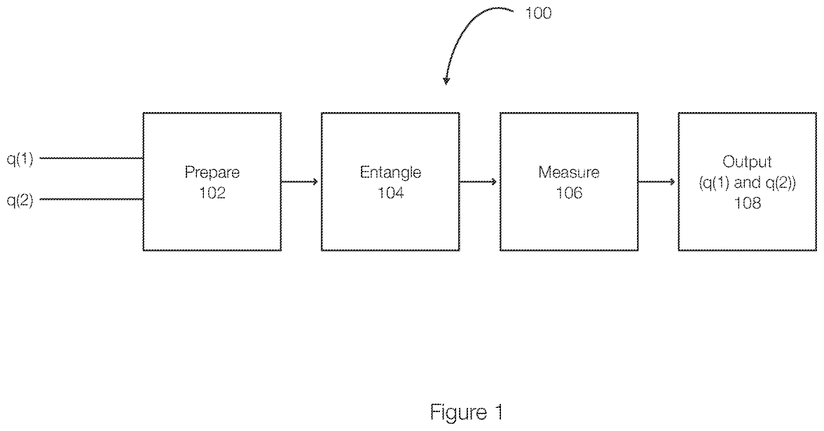

FIG. 1 discloses aspects of a quantum circuit that may be iteratively executed by a QPU. The quantum circuit 100 is provided by way of example only and embodiments of the invention are not limited to any particular type of quantum circuit. Generally, the circuit 100 may receive qubits (e.g., q(1) and q(2)) as inputs. The qubits may be initialized or prepared 102 to a particular state. Stated differently, the input qubits may be initialized based on parameters. In effect, the parameters can be viewed as the input to the circuit 100.

Once prepared, the circuit 100 can be operated or executed. Operating the circuit 100 a single time is referred to herein as a shot. In this execution, the qubits may be entangled 104 (e.g., using quantum gates or the like). The qubits are then measured 106 and recorded as output 108. The output is a bitstring of q(1) and q(2). Because the output 108 of the circuit 100 is probabilistic in nature, a given process may perform a plurality of shots (e.g., hundreds or thousands). The quantum circuit 100 is performed iteratively. The output 108 may be returned after all shots have been performed. The output 108 is commonly a distribution of bitstrings.

Quantum circuits, such as the circuit 100, can be used for various purposes. Quantum circuits may be used, by way of example only, to perform optimizations, machine learning, simulation, and the like. Performing large numbers of shots, however, requires time during which the job that called or required the QPU may be waiting for the output of the QPU.

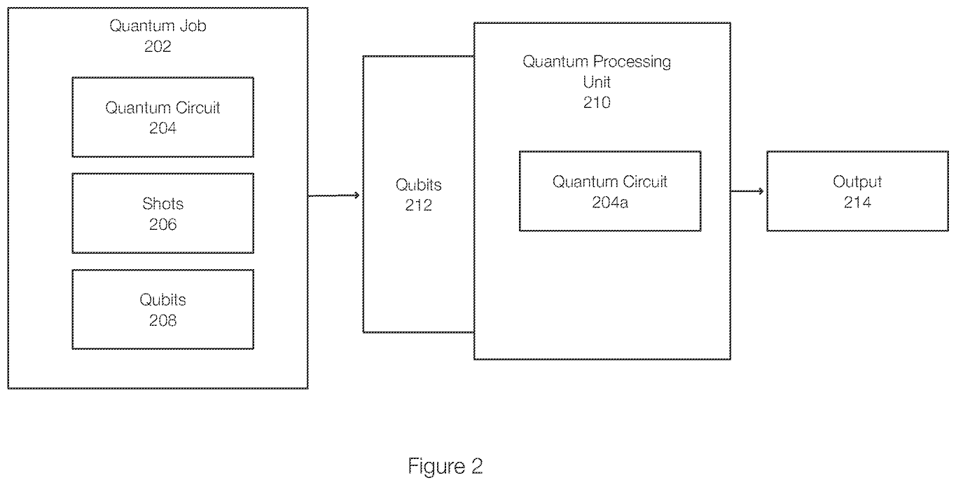

FIG. 2 discloses aspects of performing a quantum job in a quantum processing unit. In FIG. 2, a quantum job 202 has been submitted for execution by a quantum processing unit 210. The quantum job 202 may include information or artifacts such as a quantum circuit 204, number of shots 206, and number of qubits 208. Using this information, the quantum processing unit 210 will perform the quantum circuit 204 a number of times equal to the number of shots 206. The quantum circuit 204 will use the number of qubits 208 specified in the quantum job 202.

In this example, the quantum processing unit 210 is configured with the quantum circuit 204, represented as quantum circuit 204a. The quantum processing unit 210 may have n qubits 212 available. The n qubits 212 is typically greater than the number of qubits 208 required by the quantum circuit 204. Once the quantum circuit 204a is configured, the specified shots 206 are performed. This generates an output 214. Each shot results in a bitstring whose length is equal to the number of qubits 208. The output 214 commonly includes a distribution of bitstrings.

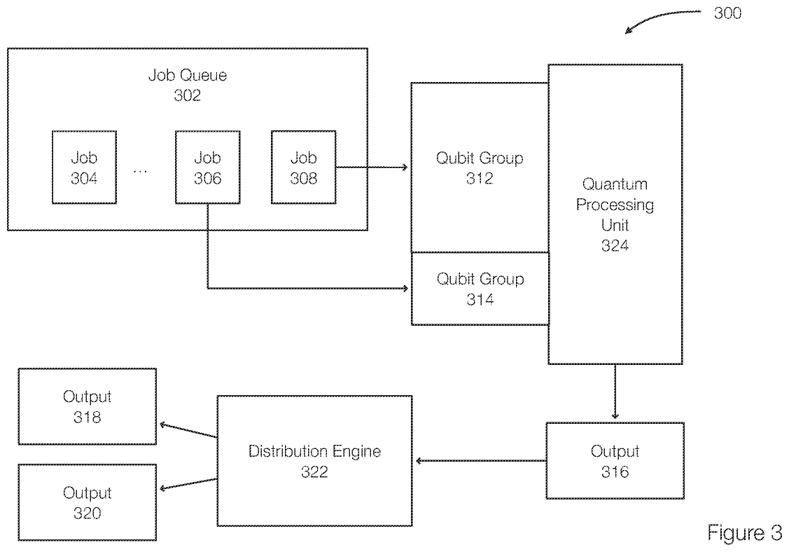

FIG. 3 discloses aspects of distributing quantum jobs or slicing a quantum processing unit into portions or partitions. FIG. 3 illustrates a quantum processing unit 324 associated with n qubits. The n qubits are illustrated as groups of qubits in this example: qubit group 312 and qubit group 314. The number of qubits each of the qubit groups 312 and 314 can vary and may depend on the quantum jobs being performed by the quantum processing unit 324. The number of qubit groups may vary and may depend on the number of quantum jobs being performed simultaneously. The number of qubits in any group is determined by the qubits required by the corresponding quantum job.

Generally, quantum jobs in the job queue 302 are submitted to the quantum processing unit 324 in order of entry. Embodiments of the invention allow more than one of the quantum jobs in the job queue 302 to be submitted at the same time. Depending on the specific metadata or characteristics of each of the quantum jobs, this may allow some jobs to jump ahead in the queue. In one example, the process of determining which jobs to submit includes the job at the front of the job queue 302.

A distribution engine 322 is configured to manage the job queue 302. The job queue 302 includes jobs that have been submitted to or that will be submitted to the quantum processing unit 324. In this example, the job queue includes quantum jobs, which are represented by quantum jobs 304, 306, and 308.

The performance of the system 300 is improved when more than one of the jobs in the job queue 302 are performed at the same time. Running a single job at a time may leave, for example, the qubit group 314 unused. Running multiple quantum jobs at the same time improves the performance of the system 300 at least because fewer resources (qubits) of the quantum processing unit 324 are left idle. This also benefits the vendor because more jobs can be performed in a shorter amount of time. Further, the user may receive their results more quickly as the user does not need to wait for jobs further in the queue to be performed sequentially.

The distribution engine 322 may give the user an opportunity to opt in to allowing their job to be performed with another user's job at the same time on the same quantum processing unit 324. Unless entangled, qubits of the quantum processing unit 324 can be independent of each other. As a result, the quantum processing unit 324 can ensure that the job of one user does not interfere or impact the job of another user, even when run concurrently and when all of the quantum jobs include quantum circuits that entangle some of the job's qubits.

In order to execute jobs from different users at the same time on the same quantum processing unit 324, the user may opt into this benefit or give permission. When opting in, the user may specify certain tolerances. More specifically, running two jobs at the same time on the same quantum processing unit is more complex than simply ensuring that the number of qubits required for the two jobs is equal to or less than the number of qubits available on the quantum processing unit. A user may also need to agree to a potential change in the number of shots and/or other parameters. For example, a user may request that their 20 qubit quantum circuit be executed for 512 shots. The first user may set a tolerance that allows their quantum circuit to be run with another circuit that requires 1024 shots.

The distribution engine 322, when matching jobs that can be executed on the same quantum processing unit 324, accounts for number of qubits and number of shots using user defined tolerances.

The following discussion assumes that a user has given permission or opted in to allowing their jobs to be executed concurrently or simultaneously with jobs of other users on the same quantum processing unit 324. This permission may also include adjusting the number of shots.

In this example of FIG. 3, the distribution engine 322 determines that the job 306 and the job 308 can be performed concurrently on the quantum processing unit 324. Thus, the job 308 is assigned to the qubit group 312 and the job 306 is assigned to the qubit group 314. The two jobs 306 and 308 are executed according to the job with the higher number of shots. Thus, if the job 306 specifies 512 shots and the job 308 specifies 1024 shots, 1024 shots are performed for both jobs.

Executing the jobs 306 and 308 concurrently results in an output 316 from the quantum processing unit 324. The output 316 may include a bitstring distribution for all qubits of the quantum processing unit 324 (group 312 and group 314) that were used. The distribution engine 322 (or the quantum processing unit 324) may separate the distributions into outputs 318 and 320. The output 318 corresponds to the bitstring distribution for the job 308 and the output 320 corresponds to the bitstring distribution for the job 306. For example, if the quantum processing unit 324 accommodated 50 qubits, the job 308 used 30 qubits, and the job 306 used 20 qubits, the output 316 would be a bitstring distribution of 50 bits, the output 318 would be a bitstring distribution of 30 bits, and the output 320 would be a bitstring distribution of 20 bits. In this example, the quantum circuit executed for the qubit group 312 is different from the quantum circuit executed for the qubit group 314.

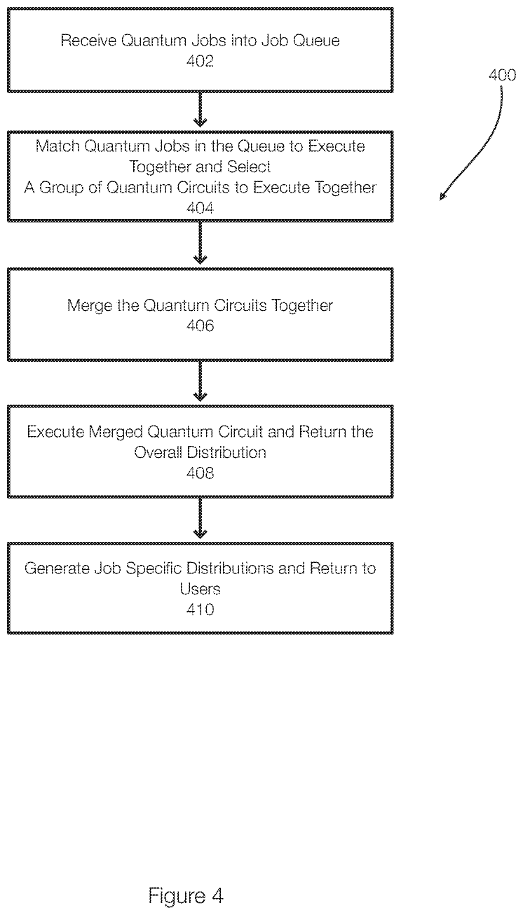

FIG. 4 discloses aspects of slicing the quantum processing unit in order to perform quantum jobs in a shared manner. In the method 400, quantum jobs are received 402 into a job queue. When a quantum job enters the queue, the distribution engine may determine whether the user that submitted the job allows the job to be matched with other jobs. This allows the distribution engine to identify quantum jobs that can be executed together in the same quantum processing unit. This analysis may include ensuring that the jobs have qubit requirements that are cumulatively have less than or equal to the number of qubits of the quantum processing unit. When the number of shots for the jobs being evaluated do not match, the distribution may ensure that the shots added to at least one of the jobs is within a tolerance determined by the corresponding user.

Based on this information, the distribution engine matches 404 quantum jobs in the queue to execute together in the same quantum processing unit. Matching may include various possibilities. For example, if there are 6 quantum jobs in the job queue numbered 1-6 where job 1 is in the front of the queue and has been in the job queue the longest, the distribution engine may determine that jobs 1, 3, and 5 can be executed together and that jobs 2 and 4 can be executed together. In this example, the jobs 1, 3, and 5 are performed first at least because the job 1 has been in the job queue the longest and is in the front of the job queue.

Once the quantum jobs are matched and a group of quantum jobs are selected, the distribution engine may merge the quantum circuits in the jobs in the selected group. This may include assigning each of the quantum circuits to a range of the quantum processing unit's qubits. This ensures that the quantum circuits are still independent of each other such that the execution/output for one quantum circuit does not impact the execution/out of other quantum circuits being concurrently executed. Further, these independent quantum circuits do not entangle with each other.

Once the quantum circuits are merged, the quantum processing unit executes 408 the merged or combined quantum job and returns an overall distribution. The distribution engine generates or separates 410 the overall distribution into distributions corresponding to the each of the quantum jobs or circuits that were merged. The results of each quantum job are returned to the corresponding process or user.

This provides several advantages. For example, the vendor uses a higher percentage of available qubits. This improves the utilization of the vendors quantum processing units. This may also reduce the queue size for quantum vendors. As a result, fewer resources are required to store the quantum jobs in the queue and wait times (time waiting for the quantum job to be performed and results returned) can be reduced. In effect the time a quantum job spends in the job queue is reduced. This may also reduce network traffic to the vendor's servers.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, slicing operations (e.g., performing multiple quantum circuits from different users at the same time in the same quantum processing unit), quantum job analysis operations, quantum job matching operations, job queue management operations, result slicing operations (slicing the results into the results of the specific quantum jobs), or the like or combination thereof.

Embodiments of the invention may be implemented in or performed by Qiskit Dell Runtime. New and/or modified data collected and/or generated in connection with some embodiments, may be stored in a data protection environment that may take the form of a public or private cloud storage environment, an on-premises storage environment, and hybrid storage environments that include public and private elements

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VM).

Particularly, devices (e.g., devices in a hybrid classical-quantum system) in the operating environment may take the form of software, physical machines, containers, or VMs, or any combination of these, though no particular device implementation or configuration is required for any embodiment.

It is noted that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

Following are some further example embodiments of the invention. These are presented only by way of example and are not intended to limit the scope of the invention in any way.

Embodiment 1. A method, comprising: receiving quantum jobs in a job queue, wherein the quantum jobs are configured to be run on a quantum processing unit, matching at least a first quantum job and a second quantum job for concurrent execution on the quantum processing unit, merging a first quantum circuit in the first quantum job with a second quantum circuit in the second quantum job into a final quantum job, executing the final quantum job on the quantum processing unit, returning results of the final quantum job, and separating the results into first results associated with the first quantum job and second results associated with the second quantum job.

Embodiment 2. The method of embodiment 1, wherein the first quantum circuit requires x qubits, the second quantum circuit requires y qubits, and the quantum processing unit includes at least x+y qubits.

Embodiment 3. The method of embodiment 1 and/or 2, wherein the first quantum job is assigned a first group of qubits of the quantum processing unit including qubits 1 to x and wherein the second quantum job is assigned a second group of qubits including qubits from qubit x+1 to qubit x+y.

Embodiment 4. The method of embodiment 1, 2, and/or 3, wherein the first quantum job is independent of and does not entangle with the second quantum job.

Embodiment 5. The method of embodiment 1, 2, 3, and/or 4, wherein a number of shots associated with the first quantum job is less than a number of shots associated with the second quantum job, further comprising determining a shot tolerance associated with the first quantum job.

Embodiment 6. The method of embodiment 1, 2, 3, 4, and/or 5, wherein the shot tolerance is associated with the first quantum job, further comprising performing a number of shots of the final quantum job equal to the number of shots associated with the second quantum job.

Embodiment 7. The method of embodiment 1, 2, 3, 4, 5, and/or 6, further comprising providing the first results to a first user and providing the second results to a second user.

Embodiment 8. The method of embodiment 1, 2, 3, 4, 5, 6, and/or 7, further comprising matching a plurality of jobs for concurrent execution as long as a total number of qubits required by the plurality of jobs is less than or equal to a number of qubits provided by the quantum processing unit.

Embodiment 9. The method of embodiment 1, 2, 3, 4, 5, 6, 7, and/or 8, further comprising including at least a quantum job at a front of the job queue in the final quantum job.

Embodiment 10. The method of embodiment 1, 2, 3, 4, 5, 6, 7, 8, and/or 9, wherein other jobs included in the final quantum job may be included even though other quantum jobs are ahead in the job queue.

Embodiment 11. A method for performing any of the operations, methods, or processes, or any portion of any of these, or any combination thereof, disclosed herein.

Embodiment 12. A non-transitory storage medium having stored therein instructions that are executable by one or more hardware processors to perform operations comprising the operations of any one or more of embodiments 1-11.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’, ‘component’, ‘agent’, or ‘engine’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

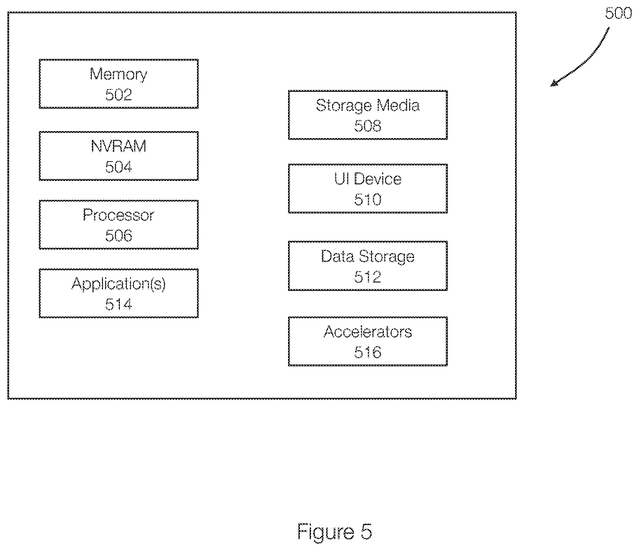

With reference briefly now to FIG. 5, any one or more of the entities disclosed, or implied, by Figures and/or elsewhere herein, may take the form of, or include, or be implemented on, or hosted by, a physical computing device, one example of which is denoted at 5. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid-state device (SSD) storage. As well, one or more applications 514 may be provided that comprise instructions executable by one or more hardware processors 506 to perform any of the operations, or portions thereof, disclosed herein. The computing device 500 may include, be associated with, or have access to accelerators 616 such as quantum processing units and virtual quantum processing units (quantum processing units emulated in a CPU environment).

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving quantum jobs in a job queue, wherein the quantum jobs are configured to be run on a quantum processing unit;
matching at least a first quantum job and a second quantum job for concurrent execution on the quantum processing unit;
merging a first quantum circuit in the first quantum job with a second quantum circuit in the second quantum job into a final quantum job;
executing the final quantum job on the quantum processing unit;
returning results of the final quantum job; and
separating the results into first results associated with the first quantum job and second results associated with the second quantum job.

2. The method of claim 1, wherein the first quantum circuit requires x qubits, the second quantum circuit requires y qubits, and the quantum processing unit includes at least x+y qubits.

3. The method of claim 1, wherein the first quantum job is assigned a first group of qubits of the quantum processing unit including qubits 1 to x and wherein the second quantum job is assigned a second group of qubits including qubits from qubit x+1 to qubit x+y.

4. The method of claim 3, wherein the first quantum job is independent of and does not entangle with the second quantum job.

5. The method of claim 1, wherein a number of shots associated with the first quantum job is less than a number of shots associated with the second quantum job, further comprising determining a shot tolerance associated with the first quantum job.

6. The method of claim 5, wherein the shot tolerance is associated with the first quantum job, further comprising performing a number of shots of the final quantum job equal to the number of shots associated with the second quantum job.

7. The method of claim 6, further comprising providing the first results to a first user and providing the second results to a second user.

8. The method of claim 1, further comprising matching a plurality of jobs for concurrent execution as long as a total number of qubits required by the plurality of jobs is less than or equal to a number of qubits provided by the quantum processing unit.

9. The method of claim 1, further comprising including at least a quantum job at a front of the job queue in the final quantum job.

10. The method of claim 9, wherein other jobs included in the final quantum job may be included even though other quantum jobs are ahead in the job queue.

11. A non-transitory storage medium having stored therein instructions that are executable by one or more hardware processors to perform operations comprising:
receiving quantum jobs in a job queue, wherein the quantum jobs are configured to be run on a quantum processing unit;
matching at least a first quantum job and a second quantum job for concurrent execution on the quantum processing unit;
merging a first quantum circuit in the first quantum job with a second quantum circuit in the second quantum job into a final quantum job;
executing the final quantum job on the quantum processing unit;
returning results of the final quantum job; and
separating the results into first results associated with the first quantum job and second results associated with the second quantum job.

12. The non-transitory storage medium of claim 11, wherein the first quantum circuit requires x qubits, the second quantum circuit requires y qubits, and the quantum processing unit includes at least x+y qubits.

13. The non-transitory storage medium of claim 11, wherein the first quantum job is assigned a first group of qubits of the quantum processing unit including qubits 1 to x and wherein the second quantum job is assigned a second group of qubits including qubits x+1 to qubit x+y.

14. The non-transitory storage medium of claim 13, wherein the first quantum job is independent of and does not entangle with the second quantum job.

15. The non-transitory storage medium of claim 11, wherein a number of shots associated with the first quantum job is less than a number of shots associated with the second quantum job, further comprising determining a shot tolerance associated with the first quantum job.

16. The non-transitory storage medium of claim 15, wherein the shot tolerance is associated with the first quantum job, further comprising performing a number of shots of the final quantum job equal to the number of shots associated with the second quantum job.

17. The non-transitory storage medium of claim 16, further comprising providing the first results to a first user and providing the second results to a second user.

18. The non-transitory storage medium of claim 11, further comprising matching a plurality of jobs for concurrent execution as long as a total number of qubits required by the plurality of jobs is less than or equal to a number of qubits provided by the quantum processing unit.

19. The non-transitory storage medium of claim 11, further comprising including at least a quantum job at a front of the job queue in the final quantum job.

20. The non-transitory storage medium of claim 19, wherein other jobs included in the final quantum job may be included even though other quantum jobs are ahead in the job queue.
